(19) United States
(12) Patent Application Publication
(10) Pub. No.: US 2007/0120588 A1
(43) Pub. Date: May 31, 2007

(54) Low-jitter clock distribution

(76) Inventors: Chee How Lim, Hillsboro, OR (US); Guneet S. Singh, Santa Clara, CA (US); Henry Guo, San Jose, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/291,204

(22) Filed: Nov. 30, 2005

(51) Int. Cl. G06F 1/04

(52) U.S. Cl. 327/291

(57) ABSTRACT

A first oscillatory signal is distributed to a number of destinations in an integrated circuit die. The frequency of a second oscillatory signal is made to track the average frequency of the first oscillatory signal, using an injection locked oscillator, as such rejecting high frequency jitter. The second oscillatory signal is provided to one or more of the destinations. Other embodiments are also described and claimed.

### BACKGROUND

An embodiment of the invention relates to the distribution of a clock signal among integrated circuitry in way that reduces jitter at the destination of the clock. Other embodiments are also described.

Presently, integrated circuits and, in particular, relatively large scale integrated circuits, require that a clock signal be distributed to numerous locations or destinations throughout an integrated circuit die. Examples of such integrated circuits include processors, system interface chips, and memory devices. Previously, the frequencies of the clock signals in such integrated circuits were low enough, such that the difference in phase between the clock signal at one point in the integrated circuit die and the clock signal at another point in the integrated circuit die was negligible. However, with the advent of integrated circuits that operate at relatively “high speeds”, i.e. using a clock of about one GHz and above, careful attention must be paid to the clock distribution arrangement so that functional units that are relatively far apart on the integrated circuit die from each other nevertheless enjoy the same timing as provided by the same clock signal that has been distributed to those locations. High performance clock distribution networks have been developed that generate a coherent clock signal across a relatively large area in the integrated circuit die. For example, one technique used to decrease the phase difference or skew between two locations is to split the clock network into two parts where each part distributes the clock signal to one-half of the die. This allows clock line lengths to be shortened, but also yields a symmetrical arrangement (thereby helping reduce the difference in skew at corresponding locations that may be at essentially opposite ends of the die).

In order for the functional unit blocks (FUBs) of an integrated circuit die to operate correctly at high clock frequencies, the clock signal that is received at a destination FUB should also be relatively stable. The stability of a clock is sometimes evaluated in terms of jitter. Jitter may be defined as the deviations in a clock's transitions, from their ideal positions. For high speed integrated circuits, jitter is now typically specified as + or − a number of picoseconds (ps). One category of jitter is referred to as “cycle-to-cycle” jitter, which is the change in a clock's transition from its corresponding position in the previous cycle. This type of high frequency jitter measurement is in contrast to period jitter, which is the maximum change in a clock's output transition from its ideal position, and long-term jitter which measures the maximum change in a clock's transition from its ideal over a large number of cycles.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” embodiment of the invention in this disclosure are not necessarily to the same embodiment, and they mean at least one.

FIG. 1 is a block diagram of a clock distribution network, in accordance with an embodiment of the invention

FIG. 2 is a block diagram of a clock distribution network, in accordance with another embodiment of the invention.

FIG. 3 is a circuit schematic of an injection locked oscillator (ILO), in accordance with an embodiment of the invention.

FIG. 4 is a plot of simulation results showing the behavior of an ILO responding to an example, cycle-to-cycle jitter.

FIG. 5 is a plot of simulation results showing the behavior of an ILO responding to an example, input step function.

FIG. 6 is a block diagram of a system, in accordance with an embodiment of the invention.

### DETAILED DESCRIPTION

After going through a clock distribution network in an integrated circuit (IC), a clock signal can become corrupted with cycle-to-cycle jitter that may have been caused by high frequency noise in the power supply or in the substrate. Timing analysis has shown that such jitter significantly impacts the “eye closure” or “eye opening” which is the defined, timing window that is available for an I/O buffer that is using the clock to drive or sense a symbol, to or from its associated transmission line. An embodiment of the invention is directed to a low titter, clock distribution network that can properly reject such cycle-to-cycle or “high frequency” jitter in a clock that has been distributed to multiple I/O buffers. Other embodiments are also described.

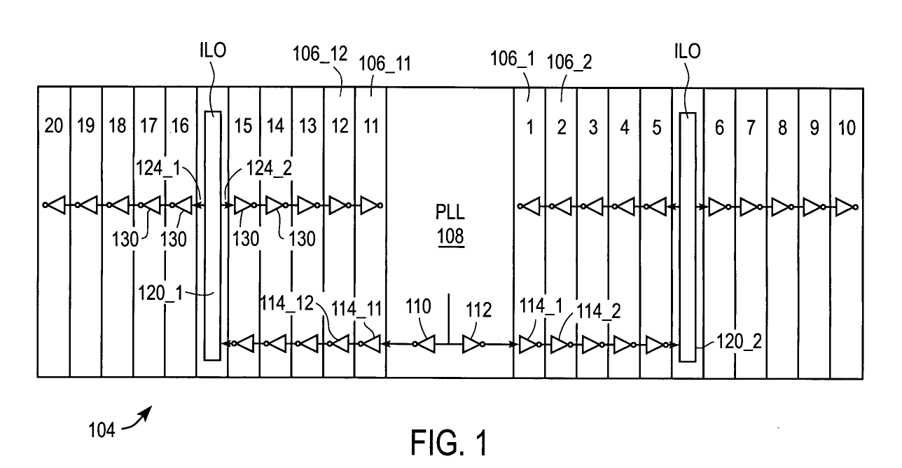

Referring to FIG. 1, a block diagram of a clock distribution network 104 is shown, in accordance with an embodiment of the invention. This network may be used to distribute a precisely controlled (frequency-wise) oscillatory signal (also referred to as a clock signal or simply clock) towards two or more destinations 106_1, 106_2, . . . that, in this example, are positioned side-by-side in an integrated circuit die. A destination 106 is a location at which the clock is received and consumed, that is used for performing certain events in accordance with the timing provided by the clock. As an example, the destinations 106 may be the I/O buffers of an I/O interface for a chip-to-chip interconnect. Other applications of the clock distribution network include delivering the clock to other types of I/O buffers, or to a number of parallel computing FUBs that are built side by side on the same chip or die.

Returning to FIG. 1, the clock distribution network 104 is to distribute a first oscillatory signal that, in this case, has been generated by a phase locked loop (PLL) 108 that is on-chip with the network 104. The PLL 108 controls the phase and frequency of an oscillator in a closed control loop, in accordance with a reference signal (not shown). This reference signal may be generated by a precision oscillator, such as a crystal oscillator (not shown). The PLL 108 may be designed to multiply up the frequency of the reference signal, into that of the first oscillatory signal. In other embodiments, the first oscillatory signal may have been generated off-chip by an off-chip PLL. For example, the first oscillatory signal may be a clock signal that has been propagated together with one or more separate data signals on a group of transmission lines, from another integrated circuit component in the system.

The clock distribution network of FIG. 1 has two halves. The first oscillatory signal is split and driven into both halves by respective buffers 110, 112. Depending on the distance that the clock is to be propagated, one or more additional, intermediate buffers 114 may be inserted in the network 104. Such buffers 114 are generally speaking amplifiers that do not have any special frequency control capabilities, and are therefore relatively compact. This is in contrast to a PLL buffer that has a complex, frequency control loop and whose output may be capable of providing a zero-delay signal relative to the input.

Between the one or more intermediate buffers 114 and the destinations 106, an injection locked oscillator (ILO) 120 is coupled to the distribution network 104. The ILO 120 has an injection input 122 to receive the clock from the one or more intermediate buffers 114, and one or more oscillator outputs 124 to send the clock to one or more of the respective destinations 106.

The ILO 120 generates its output oscillatory signal in such a way that the frequency of this output signal tracks slow changes but rejects fast changes in the frequency of the first oscillatory signal (at the injection input 122), as such attenuating high frequency jitter. The ILO can track the average frequency of the signal at its injection input, all the while rejecting a certain amount of cycle-to-cycle jitter that may also be present at the injection input. Although a PLL buffer may outperform an ILO in terms of jitter rejection, it will do so at significantly greater expense (due to greater circuit complexity and required chip area).

The use of the ILO in the clock distribution network, as described here, may be viewed as shifting the design focus from rejecting noise along the distribution network, to tolerating the noise at or near the point where the clock will be consumed (e.g., the destinations 106) by in effect absorbing and filtering the cycle-to-cycle jitter. In other words, referring to FIG. 1, phase noise that appears at the injection input 122 is essentially low-pass filtered (higher frequency components are rejected) at the output 124.

In one application, the ILO may be designed as a first harmonic ILO, meaning that the frequency of the output oscillatory signal is essentially the same as the fundamental frequency of the injection signal. In other applications, however, the ILO may be designed so that the frequency at its oscillator output is a multiple of the frequency at the injection input.

The signal at the output 124 is provided to one or more destinations 106, for example, in the manner depicted in FIG. 1. There, the ILO 120 has a pair of outputs 124_1, 124_2 that feed separate halves of an integrated circuit using a symmetrical arrangement of buffers 130. In general, there may be one or more buffers 130 on each output of the ILO 120, to help propagate the oscillatory signal to their respective destination inputs. For relatively long distances, a chain of buffers 130 may be used as depicted in FIG. 1. Alternatively, if the distances are short and the buffers have sufficient drive capability, a single buffer 130 may be sufficient on each output 124 of the ILO 120.

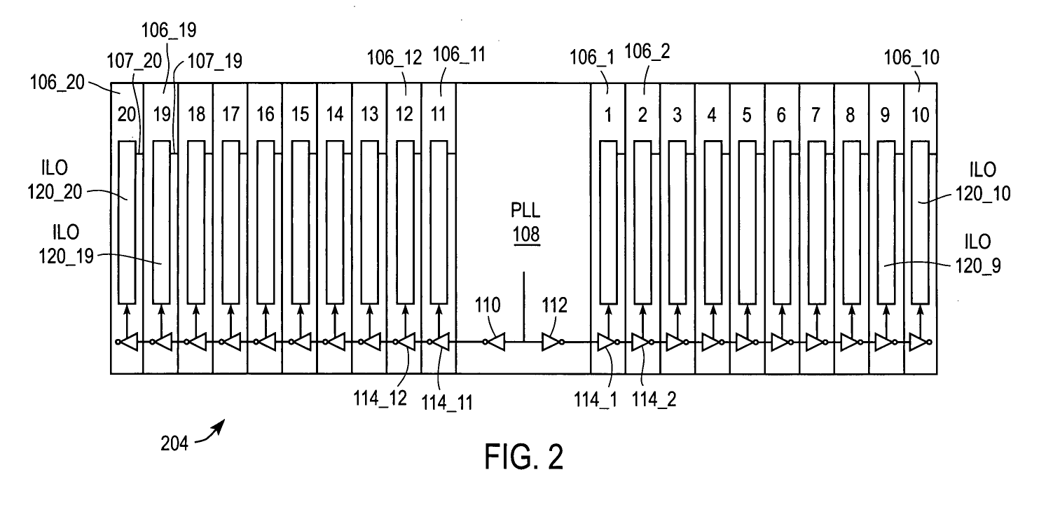

The arrangement of the clock distribution network and the ILOs are not limited to the embodiment of FIG. 1. For example in FIG. 2, an alternative embodiment is depicted where each of the destinations 106 is provided with its separate ILO 120. Since the first oscillatory signal (generated by the PLL 108) in this case also needs to travel relatively long distances through the clock distribution network, a separate intermediate buffer 114 is also provided for each destination 106. The output of one intermediate buffer 114 feeds the input of its adjacent one in sequence as shown, until the first oscillatory signal has propagated all the way to the farthest point of the clock distribution network, in this example, destination 106_20. The embodiment of FIG. 2 also has a symmetrical arrangement on either side of the PLL 108, such that replicates of the buffers 114 and ILOs 120 used on the left side of the circuit are provided on the right side (for destinations 106_1, 106_2, . . . 106_10). This type of arrangement where each destination 106 is provided with a separate ILO 120 (to provide its respective, input oscillatory signal) is possible in part due to the relatively compact circuit structure of the ILO. A schematic of an example implementation of the ILO (in complementary metal oxide semiconductor, CMOS, fabrication technology) will be described below. Before considering that practical implementation, as well as some circuit simulation results, a possible theoretical explanation is given below, to demonstrate some of the benefits of the phase noise performance of the ILO in the context of a clock distribution network.

Noise Transfer Function Derivation

To investigate the phase noise performance of an ILO, the incident signal (also referred to as the injection signal), output signal and sinusoidal noise may be defined as:
ν(t)=Vᵢ cos(ω₀t)
ν₀(t)=V₀ cos((ω₀t+Θ)
νₙ(t)=Vₙ cos((ω₀+ωₙ)t+Θ)
When the output signal is injection locked to the incident signal in the absence of noise, the input-output phase difference should be constant (Θ=Θ₀). However, when sinusoidal noise with an offset frequency ω₀ is added to the system, Θ is no longer constant and instantaneous output frequency may be defined as

$$ω = {ω}_{0} + \frac{\partial ϑ}{\partial t}$$

It is the time variation of Θ that generates phase noise in the output signal. Thus,

$$\frac{\partial ϑ}{\partial t}$$

may be approximated as

$$\frac{\partial ϑ}{\partial t} ≅ - {Δω}_{0} - \frac{1}{A} [ \frac{{V}_{i}}{{V}_{0}} sin ( ϑ ) - \frac{{V}_{n}}{{V}_{o}} cos ( ϑ ) sin ( β ) ]$$

where Δω₀ is the difference between the incident or injection frequency and the free-running frequency of the ILO, A=(2Q)/ω_{γ}, and β=ωₙt+Θₙ. Therefore, a first-order differential equation may be written as

$$\frac{ⅆ {ϑ}_{e}}{ⅆ t} + [ \frac{{V}_{i}}{{AV}_{o}} cos ( {ϑ}_{0} ) ] {ϑ}_{e} = [ \frac{{V}_{n}}{{AV}_{o}} cos ( {ϑ}_{0} ) ] sin ( {ω}_{n} t + {ϑ}_{n} )$$

Solving this differential equation will show that the noise from the external source (e.g., introduced by power supply fluctuations or substrate noise in the clock distribution network which delivers the incident signal νᵢ (t) to the injection input) is filtered with a low-pass filter effect.

It can be appreciated by those skilled in the art that the noise transfer function of an ILO may be similar to that of a first order PLL. Noise at the injection input is shaped by the low-pass filter characteristics of the noise transfer function. In addition, the ILO output signal tracks the relatively slow phase variations of the injection signal within its loop bandwidth. However, unlike a first order PLL, the loop bandwidth of the ILO appears to be a function of the amplitude of the injection signal, and may be higher for larger amplitude injection signals. These characteristics were further understood and explored using the simulation results described below.

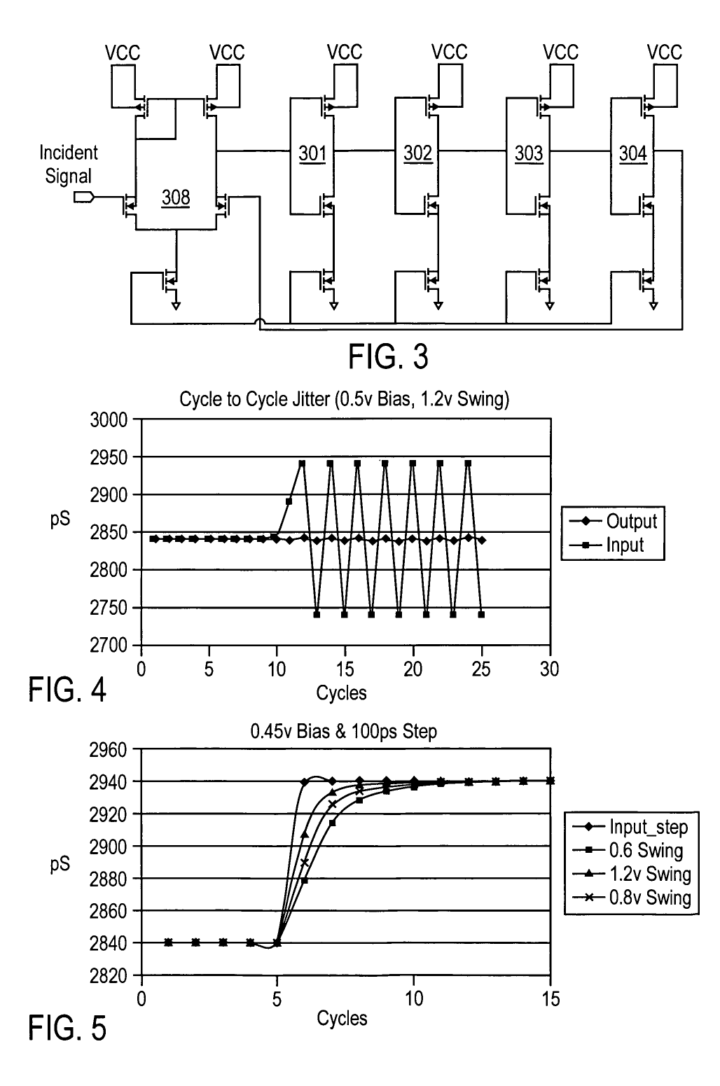

An ILO that is based on the schematic diagram of FIG. 3, was simulated using computer aided design software. This is a CMOS implementation of an otherwise free running ring oscillator that includes four inverters 301-304 in cascade. The oscillator is injection lockable, by providing the incident or injection signal to one input of a differential pair 308, while the other input receives a feedback signal from the last inverter 304. Other implementations of a free running oscillator, or other ILO designs, are possible.

The response of the system (ILO) to different types of noise at the injection input was simulated. The output or response of the system was taken at any one of the outputs of the four inverters 301-304. Simulations were also done to measure the system response to different levels of bias voltage and input voltage swing. The simulation results demonstrated that the tracking bandwidth of the ILO is proportional to the magnitude of the input signal. In other words, acquisition time of the ILO is shown to be inversely proportional to the magnitude of the input.

The frequency of the fundamental component of the injection signal and the frequency of the oscillator output signal were, in this example, the same. Under that scenario, the ILO responded to a 100 picosecond change in the period of the injection signal over a single cycle, by changing the period of the output oscillatory signal by approximately 100 picoseconds, in no earlier than three cycles. This slow step response, to a fast change in the frequency of the injection signal, became even slower when the voltage swing at the injection input was reduced. This behavior of the ILO can be appreciated from FIG. 5, which simulates the system response to a step noise at the injection input, for several different input swing voltages. The input step noise is a 100 picosecond step in the period of the injection signal, occurring in less than one cycle.

An example of the low pass filter effect of the ILO, when responding to cycle-to-cycle jitter at its injection input, is demonstrated in FIG. 4. FIG. 4 shows a simulated system response to cycle-to-cycle jitter. With the period of the injection signal oscillating between 2750 and 2950 picoseconds, and with approximately +/−100 picoseconds change in the period occurring within two cycles, it an be seen that the output period hardly varies from a steady 2850 picoseconds. In other words, fast changes in the frequency of the injection signal are rejected. More generally, an embodiment of the invention lies in the use of an ILO that, while used in a clock distribution network, can attenuate cycle-to-cycle litter at its injection input, by at least twenty times (with the frequency of the output signal being at least 1 GHz).

The embodiments of the invention are not limited to the FIG. 3 implementation that provided the above-discussed simulation results, nor are they limited to the particular simulation results depicted in FIGS. 4 and 5. Rather, other ILOs that may exhibit slightly different behavior but that nevertheless would still be effective in reducing cycle-to-cycle jitter at the destinations of a clock distribution network are included.

Referring back to the embodiments of FIGS. 1 and 2, it was mentioned above that the destinations 106 may be I/O buffers of an I/O interface. The term “I/O buffer” refers to both receive and transmit I/O buffers. The I/O buffer may be unidirectional, having a driver or receiver, but not both. Alternatively, the I/O buffer may be bi-directional, or perhaps simultaneously bi-directional. In the embodiment of FIG. 2, each I/O buffer (destination 106) has a respective clock input (not shown) that is coupled to a corresponding oscillator output 107. As an alternative, FIG. 1 shows that more than one destination 106 can have their clock inputs coupled to the same, oscillator output 124, through a chain of one or more buffers 130. These embodiments may be used in an I/O interface described below.

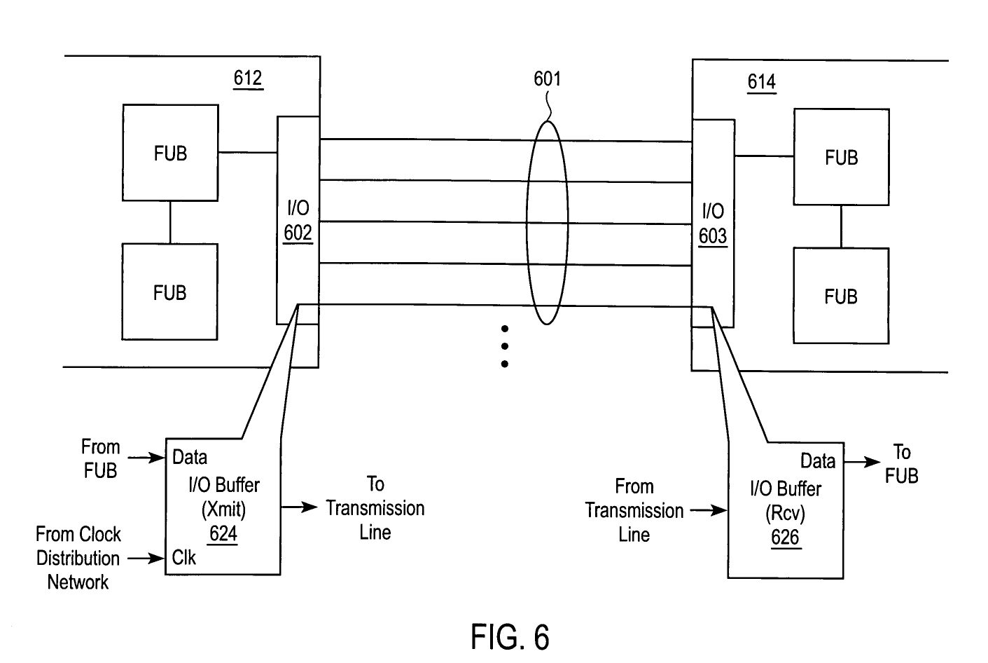

Referring now to FIG. 6, a block diagram of part of a system is shown in which a pair of integrated circuit components 612, 614 are coupled to each other by a multilane, point-to-point serial link. Each IC component has an I/O interface 602, 603 that is on-chip with one or more FUBs that are coupled to receive data through the I/O interface. For example, the IC component 612 may include a central processing unit that communicates over transmission lines 601 (which are part of a multilane serial bus) with the IC component 614 which is a system interface chipset, interconnect switch, bridge, I/O controller hub, or other part of the I/O interconnect of the system (e.g., part of the main memory subsystem). The transmission lines 601 may be formed in a carrier substrate (e.g., a baseboard printed wiring board) on which the IC components 612, 614 are also installed, and may include board-to-board connectors. The respective I/O interfaces 602, 603 have transmit and receive I/O buffers 624, 626 that translate between on-chip signaling (used by the FUBs) and off-chip or transmission line signaling. Each I/O buffer 624, 626 has one or more data ports, namely a data input and/or a data output, to receive or send a sequence of data symbols from or to an on-chip FUB. Each I/O buffer 624, 626 also has a respective transmission line port, which is AC or DC coupled to one of the transmission lines 601. For example, each transmit I/O buffer 624 may be in a separate lane of a multilane, serial link. In addition, each transmit I/O buffer has a clock input that is to receive a clock that it uses for timing its transmit events, i.e. sending the data symbols into a transmission line 601. This clock, also referred to as input oscillatory signal or the second oscillatory signal, is provided by an ILO 120 through a clock distribution network, in accordance with any of the arrangements described above (e.g., FIG. 1 and FIG. 2). It should be noted that the low jitter clock distribution technique described here may be used in systems other than the one shown in FIG. 6. For example, the IC components 612, 614 may be part of a memory subsystem in which one of the IC components is a random access memory or advanced memory buffer device that is coupled to the other IC component by a fully buffered dual inline memory module (or fully buffered DIMM, FBD) channel.

The invention is not limited to the specific embodiments described above. For example, the PLL 108 is an example of a clock generator that generates the first oscillatory signal to be distributed. As an alternative, the clock generator may include a delay locked loop (DLL) for generating the clock signal to be distributed. Also, the particular types of distribution networks shown in FIGS. 1 and 2 are just examples of a number of different clock distribution network designs (available to those of ordinary skill in the art) that can benefit from the low jitter clock distribution techniques described here. Accordingly, other embodiments are within the scope of the claims.

What is claimed is:

1. An integrated circuit comprising:
a plurality of clock destinations;
a clock distribution network to distribute a clock; and
an injection locked oscillator (ILO) coupled to the distribution network and one or more of the clock destinations, the ILO having an injection input to receive the clock and an output to send the clock to one or more of the clock destinations.

2. The integrated circuit of claim 1 wherein the clock destinations comprise a plurality of I/O buffers, respectively, each having a respective clock input, and the clock distribution network is to distribute the clock from the oscillator output to all of the respective clock inputs.

3. The integrated circuit of claim 2 wherein the distributed clock has a frequency of at least 1 GHz.

4. The integrated circuit of claim 1 further comprising another ILO coupled to the distribution network, wherein the distribution network is to distribute the clock to an injection input of said another ILO, said another ILO having an output to send the clock to another one of the clock destinations.

5. The integrated circuit of claim 4 wherein the clock destinations comprise a plurality of I/O buffers, respectively, each having a respective clock input, and wherein the distributed clock has a frequency of at least 1 GHz.

6. The integrated circuit of claim 1 wherein the ILO comprises a free running ring oscillator that is injection lockable.

7. The integrated circuit of claim 1 wherein the frequency at the oscillator output is a multiple of the frequency at the injection input.

8. The integrated circuit of claim 1 wherein the plurality of clock destinations are selected from the group consisting of transmit I/O buffers and receive I/O buffers of a multi-lane serial link.

9. The integrated circuit of claim 8 wherein the ILO comprises a ring oscillator with a differential stage, one input of the differential stage coupled to the injection input, and the other coupled to a different stage of the ring oscillator.

10. A integrated circuit comprising:
means for driving a plurality of transmission lines with symbols to be transmitted, in accordance with timing provided by an input oscillatory signal;
means for delivering a first oscillatory signal; and
means for generating said input oscillatory signal in such a way that its frequency tracks slow changes but rejects fast changes in the frequency of said first oscillatory signal.

11. The integrated circuit of claim 10 wherein the generating means has a slow step response to a fast change in the frequency of said first oscillatory signal.

12. The integrated circuit of claim 11 wherein the response time to an input step in phase or frequency indicates tracking bandwidth, so that a slower response time indicates a smaller tracking bandwidth, and wherein the generating means controls said tracking bandwidth via the amplitude of the first oscillatory signal.

13. The integrated circuit of claim 10 wherein the frequency of the input oscillatory signal is a multiple of that of the first oscillatory signal.

14. A method for distributing an oscillatory signal comprising:
distributing a first oscillatory signal towards a plurality of destinations in an integrated circuit die;
making the frequency of a second oscillatory signal track the average frequency of the first oscillatory signal using an injection locked oscillator; and
providing the second oscillatory signal to one or more of said destinations.

15. The method of claim 14 wherein the frequency of the second oscillatory tracks the average frequency of the first oscillatory signal while rejecting cycle-to-cycle jitter that was present in the first oscillatory signal.

16. The method of claim 15 wherein the frequency of the second oscillatory signal is at least 1 GHz.

17. The method of claim 15 wherein the cycle to cycle jitter is attenuated by at least twenty times.

18. The method of claim 17 wherein the frequency of the second oscillatory signal is at least 1 GHz.

19. A system comprising:
first and second integrated circuit components communicatively coupled to each other by a system interconnect bus, at least one of the components has an I/O interface that translates between on-chip signaling and transmission line signaling of the interconnect bus, the I/O interface having a plurality of transmit I/O buffers each having a respective clock input, a clock distribution network to distribute a clock, and an injection locked oscillator (ILO) coupled to the distribution network and one or more of the I/O buffers, the ILO having an injection input to receive the clock and an oscillator output to send the clock to one or more of the respective clock inputs.

20. The system of claim 19 wherein the interconnect bus comprises a multilane, point-to-point serial bus.

21. The system of claim 19 wherein the first IC component includes a central processing unit of the system, and the second IC component is selected from the group consisting of a system interface chipset, an interconnect switch, a memory controller hub, an I/O controller hub, and a main memory subsystem.

22. The system of claim 19 wherein one of the first and second IC components is a random access memory module and the system interconnect bus includes an FBD channel to couple the first and second IC components to each other.
